(19) United States
(12) Patent Application Publication
(10) Pub. No.: US 2011/0106557 A1
(43) Pub. Date: May 5, 2011

(54) NOVEL ONE INTEGRATED SYSTEM FOR REAL-TIME VIRTUAL FACE-TO-FACE ENCOUNTERS

(75) Inventor: Krishna GAZULA, Lexington, MA (US)

(73) Assignee: iHAS INC, Lexington, MA (US)

(21) Appl. No.: 12/609,409

(22) Filed: Oct. 30, 2009

(51) Int. Cl. G06Q 50/00; G06Q 10/00; G06F 3/00

(52) U.S. Cl. 705/3; 715/740

(57) ABSTRACT

A one integrated system that helps users to login using remote user interface/client—“Single Computer Screen” connected with a centralized one-integrated system (ihasClinic software framework). The ihasClinic framework allows electronic interactions using real-time audio and video between a patient, family, caregiver, medical professionals, social workers, and other professionals. The framework enables capturing standardized data, records and content of the patients, store the information captured into integrated Application database and or into its objects stored in the applications folders. The iHAS screen provides electronic interactions capabilities using real-time audio and video simultaneous interactions with a click of a button to have improved access and consultations between a patient, family, care-givers, medical professionals, social workers and specialists. The users can use iHAS screen to schedule or change or modify or delete appointments and join an interaction session

### FIELD OF THE INVENTION

The invention pertains generally to provide improved real-time collaboration using audio-video along with information from one or more applications to impact productivity of the collaborators. The inventions enable the participants to capture, store and share information (data, pictures and audio-video) during a real-time collaboration session using single computer screen between two or more participants. The invention specifically targeted to human health access improvement systems. More specifically, the invention relates to improving healthcare access by utilizing technology framework that allows the patients, family, caregivers and medical professionals to connect with each other using network communications available at businesses and homes. The framework includes an application server to process programming instructions and a iHAS Screen. The iHAS Screen, which allows a user (a patient or a medical professional or a administrator, or a care-giver) to connect with another remote user (a patient or a medical professional or a administrator, or a care-giver). The framework capture, store and process information during each interaction of a user(s) with the system. The programming instructions are organized into several modules and tightly integrated to provide efficient information capture, processing and retrieval capabilities without compromising on security of the information. The framework includes applications (such as Electronic Medical Records (EMR), Lab systems, PACS, etc.) and a unique integration engine containing a plurality of patient records which will be easy to retrieve following the business logic based on the requested subject and the said purpose.

### BACKGROUND AND DESCRIPTION OF PRIOR ART

It is known in the prior art to provide healthcare information on the networks. U.S. Pat. No. 5,867,821, which issued to Ballantyne et al on Feb. 2, 1999, for example, discloses a method and apparatus for electronically accessing and distributing personal health care information and services in hospitals and homes.

Brown, U.S. Pat. Nos. 6,101,478; 6,381,577; 6,968,375 and 6,168,563 issued on Aug. 8, 2000; Apr. 30, 2002; Nov. 22, 2005, and Jan. 2, 2001, respectively, reported a system for remote monitoring of a remote patient device. Avitall et al., U.S. Pat. No. 6,171,237 issued to on Jan. 9, 2001, reported remote patient testing units. In an another invention, a medical records maintenance system over the networks has been reported by Maus et al., U.S. Pat. No. 6,602,469 on Aug. 5, 2003. Network conversation with a remote patient over the network to assess acute medical condition has been reported by Bulat, U.S. Pat. No. 6,638,218 issued on Oct. 28, 2003.

Physiological parameter measurements on a patient who had surgery and station at home are measured and sent to a central server. These measurements are done by Hervy et al., U.S. Pat. No. 6,746,398 issued on Jun. 8, 2004. Kerr II, U.S. Pat. No. 6,942,616 issued on Sep. 13, 2005, reported measurements of physiological parameters using a device and transmitting to central location over the networks.

Image data is received in the form of a sequence of images of a patient doing tasks at a remote location is reported by David et al., U.S. Pat. No. 6,816,603 issued on Nov. 9, 2004. This image display system is similar to other video conferencing systems reported earlier. Daniel and Zipora, U.S. Pat. No. 5,544,649 issued on Nov. 9, 2004, reported video and audio streaming systems (two systems for two a communications) from patient to monitoring station and vise-a-versa. Vining et. al., US Application 20060173708 filed on Aug. 3, 2006, reported development of a system for a physician to interact with a patient while a care-giver is visiting a remote patient through video conference and make suggestions to care-giver on the treatment plan and prescriptions.

A system was developed by Quy, U.S. Pat. Nos. 6,936,007; 7,156,808; and 6,976,958, issued on Aug. 30, 2005, Jan. 2, 2007, and Dec. 20, 2005, respectively, to monitor health and disease management through a measurement of the patient using a device and transmitting using a wireless network. Further Quy reported transmitting patient monitoring data over wireless network (U.S. Pat. No. 7,156,809, on Jan. 2, 2007. Similarly Brown, US Patent Applications 20060004611 and 20070061167, respectively filed on Jan. 5, 2006, and Mar. 15, 2007, and reported a system to capture data from a remote apparatus seeking answers from patient to some questions posed by a remote medical professional to determine health condition and remotely instructing the patient on the management of the condition through programmable scripts.

TeleMedicine platforms U.S. Pat. No. 6,038,465 issued to Hewlett E. Melton, Jr. on Mar. 14, 2000, allow measurement and recording of patient's body weight. Engleson, et al., U.S. Pat. No. 7,107,106 issued on Sep. 12, 2006, reported a care management system in which management of the administration of care for patients is automated by integrating with a hospital information system and automated alarms based on the care management values.

Kumar et al., U.S. Pat. No. 7,188,151 issued on Mar. 6, 2007, reported an engine that manages transmission of the data from the patient-side device to the medical professional-side device. The reported system and method for real-time monitoring, assessment, analysis, retrieval and storage of physiological data over a wide area network. A system and method are provided for network-based monitoring of physiological data. At least one patient side device collects physiological data from a patient. A medical professional-side device receives the data from at least one patient-side device via a wide area network. An engine communicates with at least one patient-side device and the medical professional-side device. Similarly, Donald G. Ridgeway, U.S. Pat. No. 5,967,975, 1999, reported a remote monitoring system for home health parameter measurements and transmit the captured data to manage a patient from remote monitoring station. Fabian et. al., U.S. Pat. No. 6,735,479 issued on May 11, 2004, reported a measurement system for monitoring vital signs of a remote patient in order advice on changes to life style. In an another study, Brian and Breslow, US Application 20060071797 filed on Apr. 6, 2006, reported a system to capture measured data from the instruments monitoring a remote patient condition and transmitting to a remote medical professional location providing care for the patient. Rosenfeld and Breslow, U.S. Pat. No. 6,804,656, issued Oct. 12, 2004, reported a remote monitoring system for ICU patients in order to intervene in person if needed based on the measurements.

Benigno et al., U.S. Pat. No. 6,230,142, issued on May 8, 2001, reported a system to analyze captured data to determine to clinical decisions based on the analysis of a hospitalized patient to discharge and to determine post-discharge clinical pathways.

Shekelle et. al. assessed aspects of several reported systems to provide healthcare access to remote patients using video and audio communications. Based on this the worldwide available technology assessment inform this review of the industry, it is clear that most of the reported systems were based on basic video and/or audio capabilities to communicate with remote patients and capture some monitored parameters by a remote system. It has been concluded by these investigators that remote healthcare access technologies even with these basic capabilities have benefits by enabling greater continuity of care by improving access and supporting the coordination of activities by a clinician in the areas of preventive care, cardiac rehabilitation, diabetes care, etc.

Shipon, US patent application Number US20030023459, filed on Jan 30^{th}, 2003, to provide two-way communication between two participants. The approach is similar to collaboration applications already offered by WebEx, GoToMeeting etc. where users can communicate with each other share screens. It however does not offer more than two users simultaneously interacting in real-time and using single screen that defines participant specific security. Hence eliminates use of the invention for outside network for sharing medical or enterprise specific applications (such as electronic medical records, EMR, enterprise resource planning, ERP, customer resource management, CRM, etc.) and participant specific information in the single screen. Hence the reported invention has limited use at best for critical applications, such as patient care, user training, mission critical collaborations, etc.

It is apparent from the foregoing that the prior art fails to suggest, a comprehensive framework that is capable of providing two-way communication (both video and audio on demand) along with captured records integration with patients Electronic Medical Records (EMR) or Electronic Health Records (EHR) system and a decision support system for a remote patient, medical professionals, care-givers and/or administrators which eliminates the need for a patient to rush to a medical professional office, an emergency room or an hospital to seek an advice and/or care for a condition otherwise would have been possible to accomplish through this integrated framework.

### SUMMARY OF THE INVENTION

The inventors have recognized an improved healthcare access by the invention resides in its ability to allow both the patient from his/her place of residence (such home, nursing home, assisted living facility, clinic ands hospital) to connect with the medical professional and discuss the health-status through audio and video conversations along with exchange of patient information from external applications/systems including, but not limited to medical records, to asses the patient condition with increased understanding. For instance, the patient may have a cut on hand and needed immediate consultation with his/her medical professional instead of visiting urgent-care or Emergency Care facilities. The patient securely connects to the medical professionals using iHAS client application from their personal computer and a web browser (ihasRemote) with a click of a button, shows the cut using capabilities of the iHAS central server (ihasClinic) that provides real-time audio-video streaming and recording as well as ability to capture high quality images the cut if needed and store in the server. In order to minimize additional time required to make bring the patient's medical records available, the framework is fully integrated with all the necessary applications/components and allows the patient or the medical professionals to use any of the features seamlessly. The framework even allows the patient to perform the tasks using AVR (Activated Voice Response) system, without having to type any text by the user if so desired.

The iHAS Screen of the present invention allows the remote users to enter health-status changes of the patient in a standardized format in order for the framework to capture and store as the part of the patient's records, making it possible to retrieve in the future in order to understand and diagnosis the patient condition. The framework (in combination with the server, ihasClinic, and the smart client, ihasRemote) of the invention allows Software as a Service (SaaS) architecture possible and providing the remote services to achieve healthcare access anytime from anywhere, reducing costs of the healthcare. The invention, given its separable principle between the iHAS Screen (ihasRemote) and the framework, is ideally suited for the preceding application, as well as other applications wherein flexibility and economy is desired.

In addition to the foregoing attributes, the framework, in combination with the iHAS Screen, possesses numerous other process advantages and benefits over known systems. The framework improves quality of care, enhances safety of patients, and increases satisfaction of all involved. The framework improves the efficiency of the medical professional and reduces the need for use of the healthcare facilities to treat the patient or the medical professional visiting the patient placed in an off-site (homecare, nursing home or assisted living). Hence the improved efficiency allows the medical professionals to gain additional abilities to treat new additional patients without having to increase both physical and human resources. Moreover, it brings benefits to the patient by eliminating the need for traveling to clinic/hospital/care-giver to get consultation which can be accomplished using the iHAS Single Computer Screen for the routine issues and to seek medical advice.

Further more, the framework, ihasClinic, in combination with the iHAS Single Computer Screen, ihasRemote, allows capturing the patient's physiological and vital data in real-time and store. The framework features allow semi- or full automation of the data capture, eliminating all the costs, delays and errors associated with manual operations of data capture and attaching to the patient's records.

The framework also allows the user (patient/medical professional) to retrieve and generate the desired reports to gain knowledge/understanding of the patient's health-status.

In view of the above, it is an object of the present invention to provide a novel healthcare access system which successfully brings all involved, any patient, medical professionals, care-givers and/or administrators, leading to increased efficiency while driving the healthcare costs down significantly.

The present invention is directed to the field of providing information related to medicine, engineering, education and training, law or any other area of interest via computer network.

### OBJECTS AND ADVANTAGES OF THE INVENTION

In view of the problems discussed above in prior art section, it is an object of the present invention to provide one integrated system that helps users. It is important to develop sustainable infrastructure and care models to prevent unnecessary hospitalizations and ER visits by effectively managing chronic diseases and acute conditions. Telehealth is one of the effective mechanisms to enable local community healthcare centers enhance care for rural and home-bound populations. However, current telehealth solutions often involve stand-alone systems that separate the physician/nurse from their normal office setting, resulting in inefficiency and dissatisfaction. In contrast, the iHAS was designed with ease of use by providers foremost in mind, and allows physician/nurse to provide virtual face-to-face visits from the convenience of his/her own office desk, without disturbing the routine.

The iHAS approach is a mechanism for providing real-time virtual face-to-face encounters from a variety of remote locations, including the patient's home, rural healthcare centers, community healthcare centers, multi-specialty group practice centers and hospitals. This approach is designed to reduce healthcare disparities while improving a provider's productivity and efficiency, using our unique, secure and HIPAA compliant web-based system. The iHAS system is easy to use and allows physicians/nurses/other-healthcare-professionals to interact with patients/family-members/specialists from their normal office setting using a computer and webcam. Because of the unique ability of the iHAS system to present the medical record on the same screen used for the audio-video encounter, there is the potential for marked improvement in provider productivity and satisfaction. In addition, the system allows two or more participants to interact simultaneous, dramatically improving effectiveness and efficiency of the communication (as shown in FIG. 1). In summary, the iHAS approach provides two unique features:
(1) Virtual face-to-face visits between patients at home, family, nurses, advanced practice nurses, physicians, caregivers, health workers using real-time audio and video simultaneous interactions; and
(2) A Single Computer Screen solution achieved using our innovative and proprietary techniques, to bring together and display in real-time all essential components for the medical encounter. “Multi-centric system” that mimics in-office face-to-face visits, pulling all essential components of the medical encounter (audio-video, medical records, other information and patient specific intelligence, etc.) into a Single Computer Screen to optimize physician productivity and efficiency. The components simultaneously available on the screen include audio-video, electronic medical records (EMR)/application database, laboratory data, patient-entered vital signs data, home telehealth data from monitors, instructions, education/training information/documents, etc.). This unique technology allows providers to complete medical record documentation/progress-notes during a real-time virtual face-to-face encounter, thus markedly improving productivity of healthcare providers.

The iHAS system assists healthcare workers in collaborating with a patient and family to schedule appointments; maintenance and monitoring of health; review of clinical tests and follow up; access to specialists; medication reconciliation; education and training; dietary and social work consultations; counseling and advice on anxiety control in mental health issues, etc. The real-time virtual visits between patients and providers using the iHAS advanced and state-of-the-art system occur using personal computers (laptop/desktop) installed with a commonly available web browser (such as Microsoft Internet Explorer, Mozilla Firefox, etc.) and simple commercially available webcams. Patients and providers will require no other hardware or software components. The capabilities of the iHAS system include security standards (e.g. HIPAA compliance, data encryption, etc.) required for secure virtual face-to-face encounters. All functionality is provided and controlled from a centrally managed server, eliminating any complicated user setup or maintenance.

The iHAS approach is the first aggregator of all essential components of healthcare participant interactions (advanced use of real-time audio and video, with electronic medical records, lab systems, images, and other information) into a secure single computer screen.

The iHAS solution is an advanced “multi-centric system” that mimics in-office face-to-face visits and real-world scenarios involving patients, family, provider, homecare agencies, community agencies, multi-specialty group practice centers and clinical support systems (EMR, lab system, PACS, etc.). This approach will enhance access and satisfaction of both the patient and providers, and is designed to eliminate/reduce unnecessary hospitalizations/readmissions/ER visits. Since patients with chronic illnesses often fail at home, the iHAS system provides vitally needed enhanced access to assess, intervene, and prevent deterioration requiring hospitalization or emergency services. This can lead to not only to marked improvement in quality of care and patient/provider satisfaction, but a reduction in healthcare costs as well.

The capabilities of the iHAS system adhere to security standards (including HIPAA) required for real-time virtual face-to-face encounters. The approach would help improve a clinician's productivity and time by enabling (1) rapid and comprehensive self-documentation of encounters, and (2) automation of indexing for documentation of encounters and storage in the iHAS system in order to provide rapid search and retrieval capabilities. The rapid search and retrieval capabilities are achieved by utilizing the Active Intelligent Engine of the iHAS system.

The iHAS platform goal is to provide an easy to use system and eliminate any user specific setup with the use of commonly available computer components and simple access through a web browser. The users (patients and providers) would need only a computer (desktop/laptop) and an inexpensive webcam. The application is designed to provider a user with an interface to easily navigate the features of the iHAS system by clicking on icons provided on the user dashboard.

The iHAS system brings to the participants seamlessly. For example. medical professionals who provide services, patients who seek healthcare services from one or more medical professionals, care-givers, and/or administrators to login using proprietary programming scripts that connects user interface (iHAS Screen) with the centralized one-integrated system (ihasClinic—hardware and software framework) after verifying the authentication of the user who is trying to connect with the system, allows capturing standardized data, records and content of the patients, store the information captured into Electronic Medical Records (EMR) module, apply an application suite that offers an integrated EMR with capabilities to collect and present standardized data from patients and medical professionals on the health status-changes, diagnosis and treatments bring efficiency and improved compliance, review mechanism and decision process to treat a patient.

The captured data is used for perpetuating a self-learning system, ihasAnalyst, that allows improved knowledge/understanding of patient health status. Both patients and medical professionals can learn on the patient health-status changes for improved preventive care and health management using iHAS Single Computer Screen. The client is available through a variety of interface devices such as desktop, laptop, PDA and cell phone. The client provides videoconferencing capabilities with a click of a button to have improved access and consultations with the medical professionals by the patients and the care-givers/family members.

A further object of the invention is to provide one integrated system that helps users—for example patients, healthcare services providers (medical professionals and administrators) and other professionals to login using remote user interface/client (ihasRemote) connected with a centralized one-integrated system (ihasClinic—hardware and software framework). The ihasClinic framework allows capturing standardized data, records, content of the patient entered information and transactional activity relating this patient. The framework further stores the information captured into integrated Electronic Medical Records (EMR) module, and allow the extraction of stored information as desired and appropriate for the seeker (patient, medical professionals, care-givers, and/or administrators) of the information. The programming scripts collect and store all the user activities, including that on accessed information from the system in order to be compliant with regulations (e.g. HIPAA). Data/records/content (“Information”) captured include input from the users through ihasRemote and a programming script that sends the information to ihasClinic and vise-a-versa. The information is generated one or more of the following methods (1) information input through programming script that is entered by the user using user input devices, including a computer key-board; (2) a digital picture or a video stream, including generated by a video camera; and (3) information generated by an audio device, including from a telephone, audio generating devices and from activated voice recording systems.

Yet further object of the invention is to provide an application suite that offers an integrated EMR with capabilities to collect and present standardized data from patients and medical professionals on the health status-changes, diagnosis and treatments bring efficiency and improved compliance, review mechanism and decision process to treat a patient. The captured data is used for perpetuating a self-learning system, ihasAnalyst, that allows improved knowledge/understanding of patient health status and providing decision support to treat the patient. Using iHAS Screen, both a patient and his/her medical professionals can learn on the patient health-status changes in order to make decisions on treatment plans for improved preventive care and health management. The client is available through a variety of interface devices such as desktop, laptop, PDA and cell phone. The client provides video and audio conferencing capabilities with a click of a button to have improved access and consultations with the medical professionals by the patient and care-givers.

A further object of the invention is to provide a iHAS system that is designed to adapt standards as they evolve. ihasAnalyst is designed and setup to use Clinical Practice Guidelines (CPG) issued by AHRQ to provide the analysis and treatment recommendations for the medical professionals and guidance to the patients to seeks answers from the medical professionals. The benefits of ihasClinic are that it can be configured to provide approved standard guidelines and also to standardized decision support across medical professionals irrespective of medical professionals experience level as well as skill set. Moreover, the medical professionals are often several years behind updating their knowledge from the recent development in providing the treatment plans. Therefore, the framework is capable of providing evidence-based decision support for diagnosis and treatment based on the recorded responses from the patient. The benefits from the system are many but not limited to the following: They offer a readily accessible reference, providing selective access to guideline knowledge.

The invention possesses numerous benefits and advantages over known healthcare virtual/online systems. In particular, the invention utilizes network capabilities and programming scripts to facilitate remote communications (both audio and video streaming, capturing and storing high-resolution digital images, capturing health parameters monitoring and storing, and activated voice response system) between two or more participants to utilize the information stored as part of the patient medical/health records which allows saving time and resources for all the participants, thereby affording healthcare access improvement as well as user cost reductions. Moreover, the framework allows geographically located patients to get access to their medical professionals with a click of a button and reach their medical professionals anytime from anywhere in real-time and have virtual face-to-face encounter. It allows the medical professionals to reach their geographically located patients and check their health-status anytime from anywhere. Moreover, the framework makes it easy for the medical professionals to have consultations with the specialists on the patient's health-status and get disease management and treatment course without having to meet in person or moving the patient to the specialist offices or hospitals majority of the times, leading to reduction in health-care costs.

### BRIEF DESCRIPTION OF THE DRAWINGS

These and other objects and advantages will become more apparent after consideration of the ensuing description and the accompanying drawings, wherein:

FIG. 1 shows a schematic of the iHAS framework, representing components making real-time virtual collaboration sessions/visits/encounters possible using real-time audio-video and all the necessary information needed for making the virtual encounter productive and efficient.

FIG. 2 shows a schematic of iHAS framework describing 3-tier architecture to enable a real-time virtual face-to-face collaborative encounter.

FIG. 3 shows iHAS recommended physical architecture for deploying iHAS framework in an enterprise to meet all necessary security, regulatory and compliance requirements to maintain participant's privacy and data/information security.

FIG. 4: illustrates Single Computer Screen during a real-time interactions session between a patient (monitored for body weight at home), family member, a nurse and a physician, wherein the graph demonstrates healthcare team access to patient records during the interactions.

FIG. 5 is a snapshot showing body bruises of a patient, interacting with his healthcare team to describe newly developed body bruises, and the healthcare team referring to progress notes and a snapshot captured during the real-time session by the patient and stored in iHAS system.

FIG. 6 is an example of Single Computer Screen simultaneously presenting access to electronic medical records (EMR) and a lab system showing results of lab tests for the patient.

FIG. 7 is a iHAS system sharing a snapshot of a wound along with progress notes during a real-time virtual session.

FIG. 8 shows iHAS system, where the patient radio graph is shared and captured with annotated notes on the image during discussions in a real-time virtual face-to-face encounter between a doctor and a specialist (e.g. radiologist).

FIG. 9 shows a flow chart describing process performed by iHAS system, according to invention principles.

### DETAILED DESCRIPTION

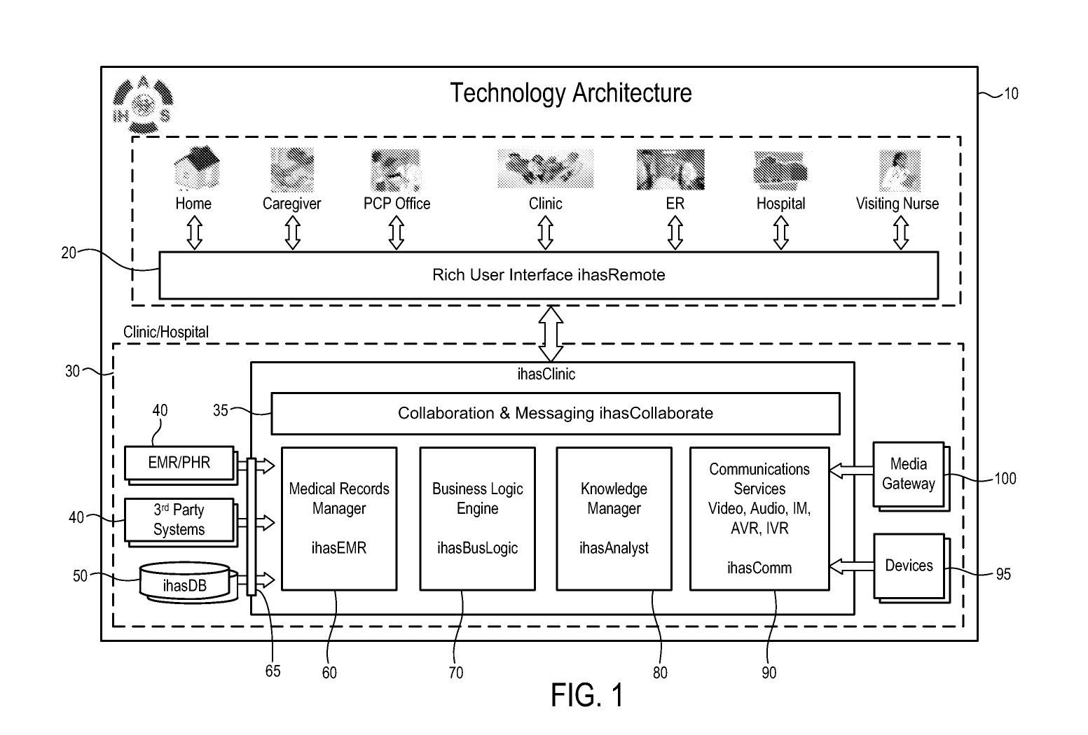

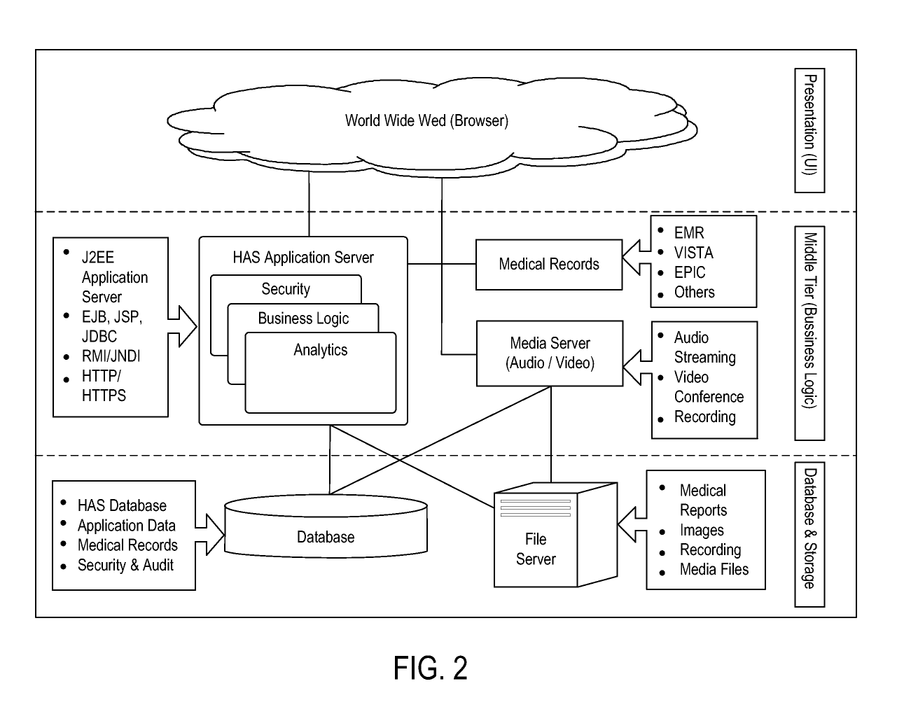

With reference to the drawings and, in particular, with reference to FIGS. 1-2, the invention comprises a technology framework, indicated generally at 10, assembly of several components to deliver an integrated solution that supports on the spot decision making for the players involved. In a healthcare setting, the players involved are the patient, his/her care-givers (including near and extended family members), medical professionals (both primary and specialists) and the administrators. The framework is defined by an integration framework, including J2EE engine, an enterprise service bus (ESB), application servers (including but not limited to JBoss, WebSphere, WebLogic, Apache, etc.), and other components as the technology evolves to meet the needs to the framework in order to deliver quick decision making and providing care advice.

The framework 30 provides capabilities with Applications/Systems Integrations Engine 40. The integrations include enterprise applications/systems, including Electronic Medical Records, EMR, (or Electronic Health Records, EHR, system), Medical Images systems (e.g. PACS), Lab systems, health monitoring devices/equipment/systems, etc. 40 and a related database 50 to capture, store and provide retrieval capabilities for all the data and records stored therein. These applications/systems are integrated into ihasClinic 30 ihasEMR module/application database 60 using our innovative interface, ihasBridge 65. The integration using the bridge 65 brings tight integration of enterprise application easy and fast as well as enables display of the data and/or records to the users during iHAS real-time collaborations based the role and authentication to access the system through iHAS Single Computer Screen, ihasRemote, 20. The programming engine, ihasBridge 65, to bridge the applications/systems and its database ihasDB 50 in order to provide access to these systems during a real-time collaboration session through the iHAS Single Computer Screen, ihasRemote 20. The data/records access requests and providing the access is provided based on the logic built in an engine, ihasBusLogic, 80. The ihasBusLogic 80 is a set of business rules and instructions, including those to check the user role, relationship tree, and their authentication to provide the right information that is desired by the user and what is allowed for the display.

The communication, including routing and delivery, between the iHAS Single Computer Screen(s) ihasRemote 20 and the framework ihasClinic 30 happens through the messaging engine ihasCollaborate 35. The messaging engine determines the components that it needs to activate based on the user preferred mode of communication and data/records the user is trying to access information, both read and/or write. The ihasCollaborate 35 allows the users (patient/family/physicians/nurse/healthcare workers/community workers/specialists) to join a real-time virtual face-to-face visit based a scheduled and confirmed visit by a patient or anyone related to patient (family/healthcare professionals). The visits are scheduled using ihasScheduler 36 in tight integration with ihasBusLogic 70 to allow authorized users to join a visit in order to be in compliance with regulations, including but not limited to HIPAA

Multiple communication channels are available to enable real-time audio-video collaborations/visits through Communications Services Engine 90. The Communications Services Engine 90 enables real-time audio-video collaborations using its Media Gateway 100. The Communication Services Engine 90 capabilities include, but not limited to, Real-Time Audio-Video Streaming and Recording 91, activated voice response (AVR) and/or interactive voice response (IVR) functionality through AVR/IVR Services API 92, and Instant Images API 93 (including high definition images if the plugged in devices 95 have the capabilities) capture and store using real-time video stream. In addition, Communications Services Engine 90 also allows the users to play/view stored videos 96, images 97 and medical image information 98 during a real-time collaboration session by the authorized users.

As shown in FIG. 1, any user would be able to input or extract data, medical records, and/or decision making information when using the system as a whole, combination of ihasClinic 30 and ihasRemote 20. The user (patient/medical professional/care-giver(s)/administrator) may input data to the ihasClinic 30 through the ihasRemote 20 or may seek records or analyzed data from the framework. If the user is feeding data/records to the framework, one or more of the APIs (65, 91, 92.93, 94, 96, 97, 98, 100), EMR records 40 through ihasBridge 65, or EMR database 50 are utilized to provide the access based on the configurations and instructions built in through hasBusLogic 70. If the user is seeking analyzed data and decision support regime from ihasClinic, the intelligent built in through ihasAnalyst 80 provides the information that is being asked by the user (patient/medical professional(s)/care-giver(s)/administrator) who has logged in through ihasRemote 20.

The module ihasAnalyst 80 is a self evolving through built-in intelligence. The self-learning capabilities are built-in through set of programming scripts that provide Artificial Intelligence capabilities 85. The module ihasAnalyst 80 takes the input from the stored data/records from EMR 40 and its database 50 along with instant data feed coming from ihasRemote 20 to analyze and to provide decision making information. The decision making information could be for self-treatment 82 or for medical professionals to provide treatment plan for a patient 82. All this is managed through a standardized information presentation 86 through ihasRemote 20. Based on the information presented to the user(s), the expert user may change the treatment plan based on their personal experience and knowledge. This change in plan is updated in the system and self-learning capability of the system updates its model 87 to use the information to provide new predictive decision making information for the users from here onwards.

The iHAS framework architecture and high level components are shown in FIG. 2. The elements necessary to provide real-time virtual face-to-face visits using iHAS framework and represents outlines the various components of the framework 10. FIG. 2 represents how the components interact with each other as well as links to external resources/applications/systems/databases. The framework 10 logical view provides a breakdown of components and classes of the API. The HAS framework is built on top of a 3-tier architecture—(1) Presentation, (2) Business Logic and (3) Database & Storage. The Presentation layer provides a Rich Internet Application (RIA) for the end-user (iHAS Single Computer Screen presentation, ihasRemote 20). The Business Logic layer implements the business logic of the iHAS framework 10, and built using J2EE standards and deployed on J2EE based application servers, including but not limited to JBoss, WebSphere, and WebLogic. The Database and File Server provides means of data and media storage that is managed by the iHAS framework.

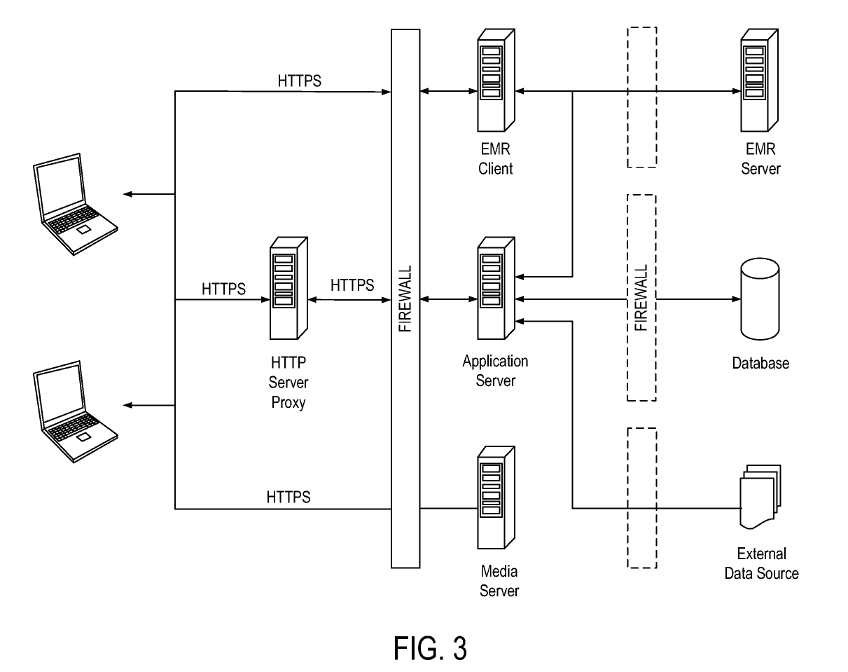

The logic and security layers are designed to operate behind firewall(s) in order to be compliant with regulations of real-time virtual face-to-face visits. The physical architecture of the iHAS framework with respect to enterprise applications/systems is described in FIG. 3. The iHAS framework 10 and it's two main components (ihasClinic 30 and ihasRemote 20) are designed to deliver a user friendly and easy to use system.

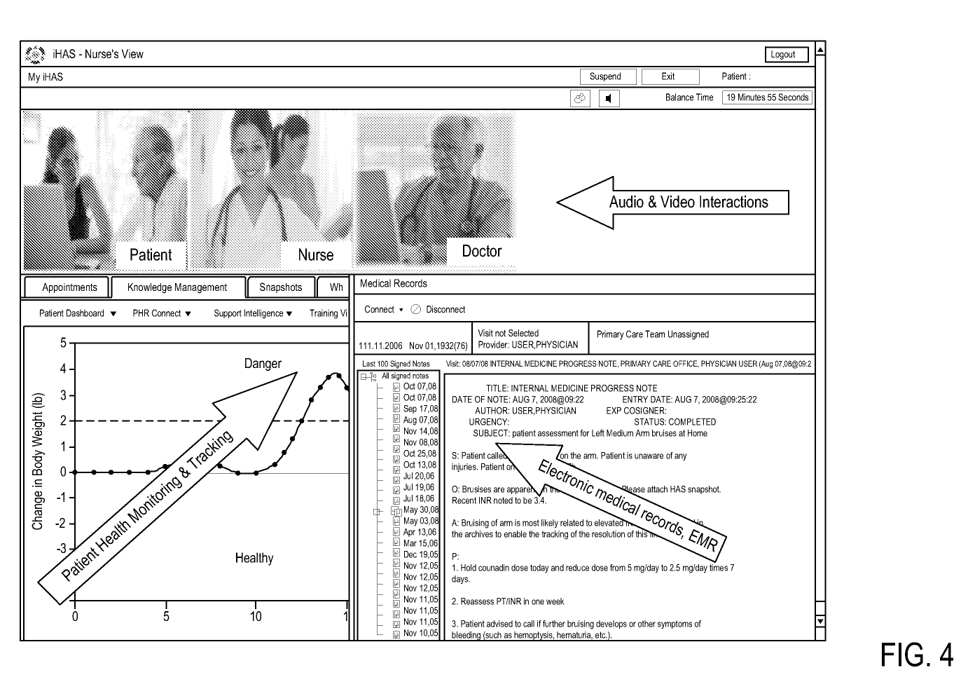

In the practice of the invention, FIGS. 4-8 show few detailed illustrations of real-time virtual face-to-face visits/encounters/collaborative-interactions using the iHAS framework. The framework enables the users to achieve a rapid and comprehensive electronic self-documentation of encounters. The framework allows two or more participants to interact in real-time and share data/information from external applications/systems during encounters/collaborative-sessions, leading to improved and efficient documentation during the encounters. This approach helps to achieve comprehensive documentation of encounters as well as rapid retrieval and inclusion of content from historic encounters through powerful search engine capabilities. The invention can be embodied in forms other than those described above.

As was previously mentioned, the capabilities of the iHAS system will adhere to security standards (including HIPAA) required for real-time virtual face-to-face encounters. This approach would help improve a clinician's productivity and time by enabling (1) rapid and comprehensive self-documentation of encounters, and (2) automation of indexing for documentation of encounters and storage in the iHAS system in order to provide rapid search and retrieval capabilities. The rapid search and retrieval capabilities are achieved by utilizing the Active Intelligent Engine within the iHAS framework.

Practicing the invention in an environment in which the healthcare professional uses a personal computer in some or all of the above-discussed ways can be advantageous, the iHAS system uses a web browser which allows participants to provide data/information (here after referred as “content”) related to the patient condition in multiple formats, including:
Patient Data (as schematically described in FIGS. 4-8): (1) typed text—reported by the patient before an encounter, edited/modified by during the encounter; (2) data on manually captured measurements, such as body weight, peak flows, etc.; (3) data from automated measurements such as from pulse oxymeter, digitized reading of lung and heart beat sounds, etc.; (4) snapshots, e.g. facial or wound condition, etc. and (5) audio and video recording of explanation of a condition or conversations
Progress Notes: Capture clinician notes into patient records during an encounter, (1) typed text, (2) snapshots, (3) audio and video recording of the conversations, (4) instant messages, IM, exchanges, and (5) details of whiteboard collaborations, including annotations, comments, drawings, etc.

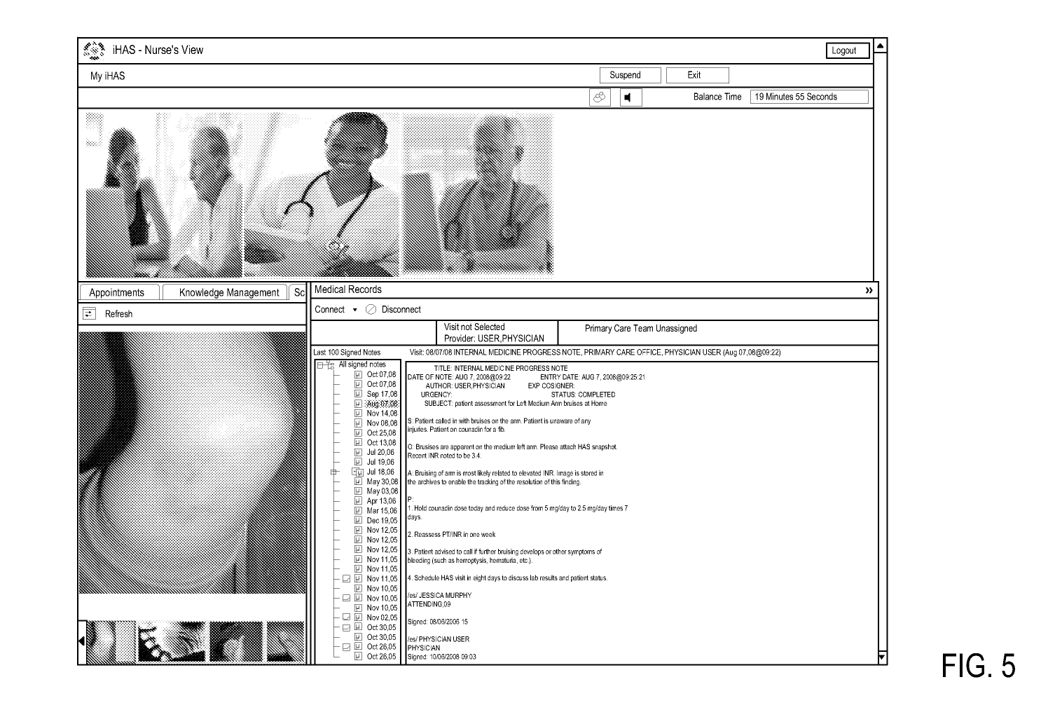

As shall be recognized upon understanding the manner in which it operates, the iHAS system, integrated with an intelligent search engine, including but not limited to Active Intelligent Engine (AIE), allows the clinician to submit a search query to rapidly retrieve the relevant information from all available sources. The searching capability is enabled by providing a Graphical User Interface (GUI) similar to a commercially available search interface wherein the user may type a few words to describe what he/she may be looking for. The search is enhanced by the system through its capabilities to build dictionaries that have been created using existing healthcare taxonomies, which are further updated through feedback loops to enhance the system continuously. The iHAS system combines the captured content from self-documented encounters and relevant content from all other linked healthcare applications/systems. Then, the iHAS system will rapidly present clinicians with comprehensive clinical data/information during an encounter. The iHAS system then combines all types of content (structured, semi-structured and unstructured), process, and allow clinicians to retrieve from (1) a specific encounter in the past for a patient, (2) all historical encounters that is matching the current encounter for a patient, and (3) all historical encounters across multiple patients that is matching the current encounter for a given patient. FIGS. 5-8 present examples of information retrieval and viewing encounter documentation utilizing the iHAS system during a real-time face-to-face visit.

As discussed above, the iHAS system employs a proprietary methodology which requires innovative integration of a new, dynamic approach to unifying information access provided by one of the next generation information search engines (such as Active Intelligent Engine (AIE) developed and marketed by Attivio). The system offers ease of use, secured information presentation, reliability, speed and efficiency of information search and presentation, and scalability. Hence, the capabilities of the iHAS framework are many but not limited to the following:
Provide capabilities to conduct virtual face-to-face real-time interactions involving two or more participants (a rural home patient, family, health workers, clinicians, specialists, dieticians, therapists, counselors and community workers).
One computer screen technology bringing a patient's medical information from different healthcare systems that are linked with the iHAS system.
Allow documentation during a real-time interaction session. The iHAS system provides a configurable template to enter progress notes by clinicians if they not already have a medical records system available to enter notes during a virtual session.
Enable advanced collaboration including real-time use of audio and video capabilities, Instant Messaging and Whiteboard during interactions with ability to record and store.
Ability to capture snapshots and attach them to reported symptoms or progress notes.
Unified Information Access: To ensure actions are based on all relevant information, the search engine will provide search for both structured data and unstructured content, consolidating results in one universal index
Real-Time Fields for real-time updates, tagging, commenting and security changes. The search engine will handle document-level security changes in real time. The search engine real-time fields can be updated instantly without needing to retrieve and re-process the rest of the content.
Facilitate training and education during a virtual face-to-face visit by providing material, including videos that may have been recorded during a previous interaction session(s)
Provide capability to a patient/family/caregiver/health worker to schedule an appointment with clinician/specialist/therapist/counselor.
Enable a patient/family/caregiver to measure and enter vital signs measurements. Interface and capture data from tele health monitors that measure vital signs.
Present intelligent patient information to clinicians that is derived and retrieved from captured and stored data/information.

The iHAS system allows virtual consultations using real-time audio-video and provides transparent whiteboard capabilities for annotation and line markers to allow professionals to discuss stored images/snapshots during consultations. These annotated notes are captured and stored and attached to patient notes. Further, the system would allow audio-video recording of the consultations and archiving in the iHAS system. Hence the discussions would present powerful information when retrieved for future reference compared to simple text based clinical notes.

Another advantage of the system includes security, wherein it guards privacy and security of the users. As was previously mentioned, the system also incorporates authorization levels and roles to access information and to allow the interactions. In order to access and participate in the interactions, a user needs to have a created profile in the system with assigned roles and authorization to access the system using a graphical user interface (GUI).

Another advantage of the system may include intelligent search, extraction and presentation. As was previously mentioned, the iHAS system presents a clinician in its GUI a “Google” like search capability to intelligently look through patient's encounter data and information, and rapidly extract and present in the form user desires. The presentation format may include charts and graphs for clinicians (as shown in FIGS. 4-8).

The ihasRemote allows a user to login into the system to report a condition(s) of a patient by an authorized user and request an appointment with the medical team. A typical interactive screen allows the user to verify his/her demographic information, select pre-described symptoms or type-in condition descriptions. The reported symptoms/descriptions are stored and made available to medical professionals before/during/after a real-time face-to-face (both virtual and/or in-office) visits. This process brings improved productivity and efficiencies to providers of healthcare, enabling improved quality of care, enhanced patient safety, and increased satisfaction while reducing healthcare delivery costs.

Objective of the iHAS framework 10 to provide Single Computer Screen, ihasRemote 20. The Single Computer Screen enables access to all the essential clinical information required to address a patient's concerns. An example of real-time virtual face-to-face visit by a patient to healthcare professionals is shown in FIG. 4, during the real-time face-to-face encounters as well as allowing the healthcare professionals to complete documentation during the encounter. The iHAS system will assist health workers in collaborating with a patient and family to schedule appointments; maintenance and monitoring of health; review of clinical tests and follow up; access to specialists; medication reconciliation; education and training; dietary and social work consultations; counseling and advice on anxiety control in mental health issues. The interactions between patients and providers using the iHAS system occur using personal computers (laptop/desktop) installed with a commonly available web browser (such as Microsoft Internet Explorer, Mozilla Firefox, etc.) and simple commercially available webcams. Patients and providers will require no other hardware or software components. The capabilities of the iHAS system will include security standards (including HIPAA) required for virtual face-to-face encounters. All functionality will be provided and controlled from a centrally managed server, eliminating any complicated user setup or maintenance.

FIG. 4 shows the real-time interaction between a patient (monitored for body weight at home), family member, a nurse and a physician. This view graph demonstrates healthcare team access to patient records during the interactions.

FIG. 5 is a snapshot showing body bruises, wherein patient is interacting with healthcare team to describe newly developed body bruises. The figure also clearly shows that the healthcare team referring to the progress notes of the patient which are stored in iHAS system during the real-time session.

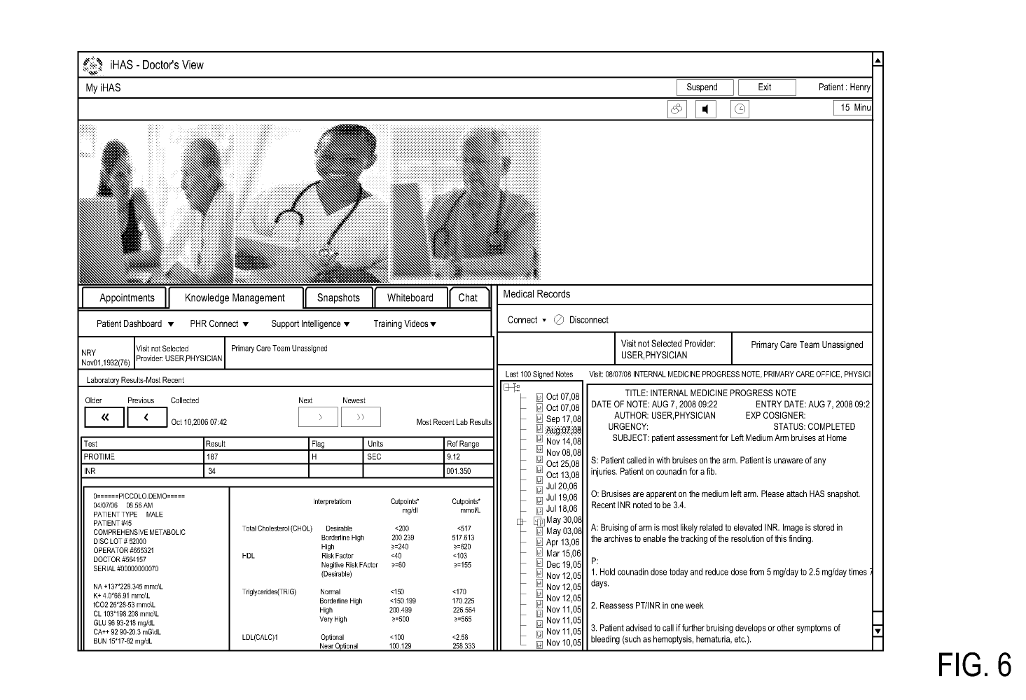

As illustrated more in detail in FIG. 6, the medical team access lab test results are displayed during the same session which further confirms that the patient's chemical compound (INR) levels measured during a lab test are elevated and hence the course of the treatment is to be altered. Accordingly the patient's doctor/nurse updates the physician/nurse progress notes in the patient electronic records.

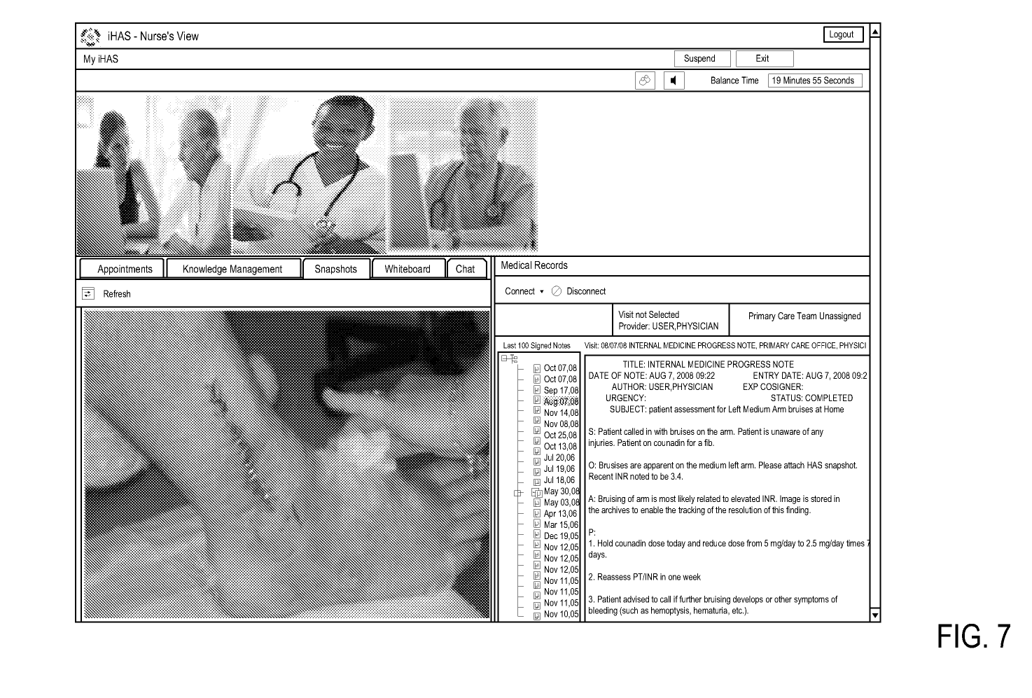

FIG. 7 illustrates a snapshot of iHAS system, where for example, the patient having a sutured wound along with progress notes during a real-time virtual session is disclosed.

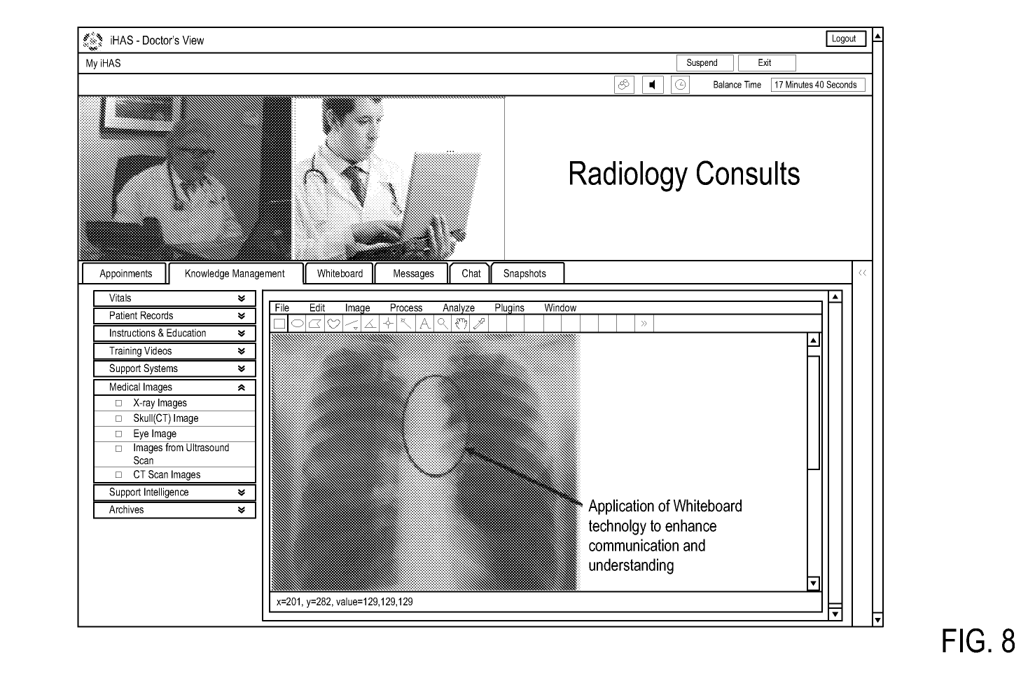

For further illustration, FIG. 8 shows iHAS system, where the patient radio graph is shared and captured with annotated notes on the image during discussions in a real-time virtual face-to-face encounter between a primary care physician and a specialist, radiologist, about the condition/severity of the diagnosis.

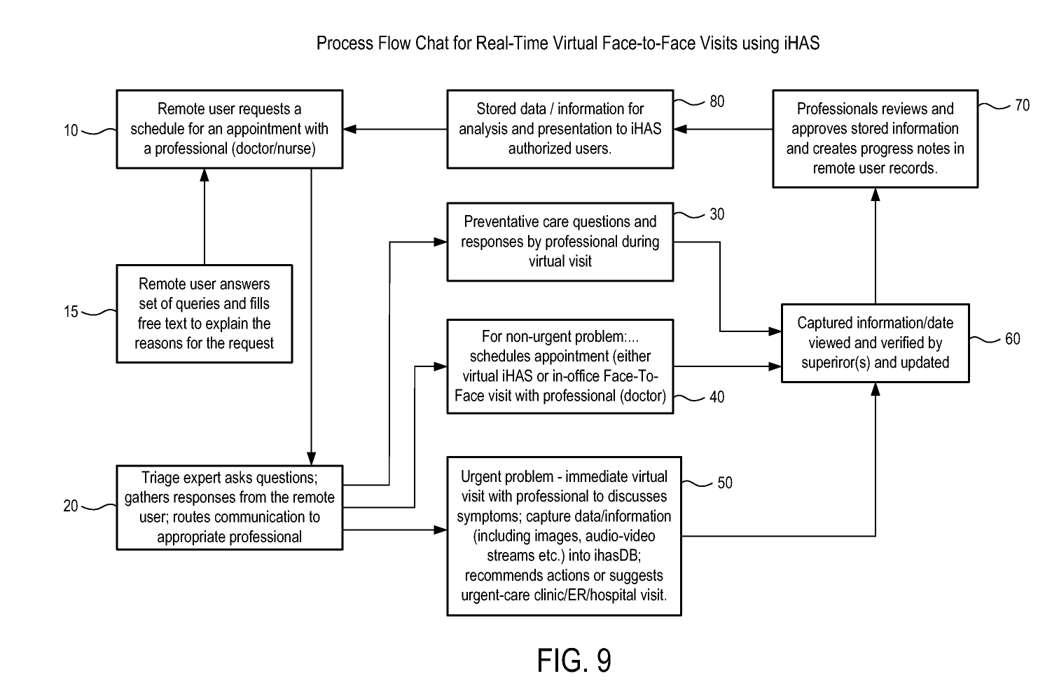

FIG. 9 shows a flow chart describing process performed by iHAS system, according to invention principles.

The present invention, therefore, provides an integrated framework in the form of a technology platform containing a plurality set of programming scripts, a database, an applications/systems (for example electronic medical records, EMR) integration engine, and a self learning analytical engine that provide information for decision making by the patient, care-giver(s), medical professional(s) or by an administrator.

Although the above description contains many specificities, these should not be construed as limitations on the scope of the present invention but merely details illustrating the presently preferred embodiment. Many other embodiments of the present invention are possible, as this invention can be used in any field where it is desirable to remotely educate an individual. For example, teachers may utilize the present invention to assign lessons to their students, and employers may utilize the present invention to provide additional job training for their employees.

Although the invention has been described in connection with a preferred embodiment, it should be understood that various modifications, additions and alterations may be made to the invention by one skilled in the art without departing from the spirit and scope of the invention as defined in the appended claims.

1. An integrated system enables visually monitoring patients and patient parameters from remote location that allows, including but not limited to, patients, caregivers and medical professionals (such as social workers, physiologists, mental health professionals, dieticians, physical therapists, etc.) wherein said system comprises a framework which is a combination of central server and web browser, said central server allows capturing standardized data, records, content of the patient entered information and transactional activity relating to a patient are stored in application database which allows the extraction of stored information as desired and appropriate for the personnel, said web browser being programmed to display a first interactive web page comprising display of audio video interactions, application data of the patient and plurality of operational mode graphical buttons; a communication service engine which enables real time audio-video collaborations using media gateway; a business logic layer which implements the business logic of the framework; a programming engine to bridge the applications/systems and its database to provide access to these systems during a real-time collaboration session through the single web browser.

2. The system of claim 1, further comprising the messaging engine determines the component that needs to activate based on the user preferred mode of communication and data/records the user is trying to access information, both read and/or write.

3. The system of claim 1, further comprising a next generation information search engines such as Active Intelligent Engine, AIE, wherein the search engine offers ease of use, secured information presentation, reliability, speed and efficiency of information search and presentation, and scalability.

4. The system of claim 1, wherein, said communication services engine capabilities are but not limited to, real-time audio-video streaming and recording; activated voice response (AVR) and/or interactive voice response (IVR) functionality through AVR/IVR Services, and instant images are captured and stored using real-time video stream.

5. The system of claim 4, wherein said communication service engine allows the users to play/view stored videos, images and medical image information during a real-time collaboration session.

6. The system of claim 2, wherein said collaborating and messaging engine comprises an electronic mail component for transmitting said supervisory instructions in an electronic mail message.

7. The system of claim 1, wherein the said framework enables capturing, storing and processing information during each interaction of a user(s) with the system and the programming instructions are organized into several modules and tightly integrated to provide efficient information capture, processing and retrieval capabilities without compromising on security of the information.

8. The system of claim 7, wherein the information access during the real-time virtual face-to-face encounter can be presented from the integrated database, external applications, or extracted, analyzed and obtainable by the users during an encounter.

9. The system of claim 1, employs security standards for e.g. HIPAA compliance, data encryption, etc. required for secure virtual face-to-face encounters.

10. The system of claim 1, wherein the browser-equipped client is one of a cell phone, a smart phone, iphone or a personal digital assistant (PDA), a laptop computer, a tablet computer (tablet PC), and a desktop computer.

11. The system of claim 1, wherein the web browser provides videoconferencing capabilities with a click of a button to have improved access and consultations with the medical professionals by the patients and the care-givers.

12. The system of claim 1, wherein the technology framework allows the patients, family, caregivers and medical professionals to connect with each other using available network communications.

13. The system of claim 1, wherein the network is at least one of a wide area network and wireless wide area network (WAN/WWAN).

14. The system of claim 1, the personnel may include patient, family member, medical professionals, care-givers, or social worker and/or administrators or any other health care professional.

15. The system of claim 1, wherein said data/record comprise a plurality of displayed icons indicating a completeness of one of the sets of patient's parameter values.

16. The system of claim 14, wherein the data/record comprise a figure.

17. The system of claim 15, wherein the figure comprises a chart.

18. The system of claim 16 wherein the chart comprises a group overview chart.

19. The system of claim 15, wherein the chart comprises one or more plots of control values versus time period since last measurement.

20. The system according to claim 1, can be directed to the field of providing information related includes but not limited to medicine, engineering, law or any other area of interest via computer network.
